(19) United States
(12) Patent Application Publication
(10) Pub. No.: US 2019/0362043 A1
(43) Pub. Date: Nov. 28, 2019

(54) DYNAMIC UPDATE OF MACRO TIMING MODELS DURING HIGHER-LEVEL TIMING ANALYSIS

(71) Applicant: International Business Machines Corporation, Armonk, NY (US)

(72) Inventors: Hemlata Gupta, Hopewell Junction, NY (US); Alexander Suess, Hopewell Junction, NY (US); Adil Bhanji, Wappingers Falls, NY (US); Nathan Buck, Underhill, VT (US); Michel P. Robert, San Francisco, CA (US); Edward Hughes, Archbald, PA (US); Kerim Kalafala, Rhinebeck, NY (US); Jennifer E. Basile, Poughkeepsie, NY (US); Jack DiLullo, Austin, TX (US); Adam Matheny, Hyde Park, NY (US); Michael H. Wood, Wilmington, DE (US)

(21) Appl. No.: 15/988,132

(22) Filed: May 24, 2018

(51) Int. Cl. G06F 17/50

(52) U.S. Cl. CPC G06F 17/5031; G06F 17/5072

(57) ABSTRACT

A system and method involves partitioning a design of an integrated circuit into two or more hierarchical levels. A lowest level includes macros and a higher level includes some or all of the macros. Each of the macros includes two or more components. A macro timing model corresponding with each of the macros indicates a delay through the macro. The macro timing model corresponding with ones of the macros that are part of the higher level are loaded to perform higher-level timing analysis, which indicates a delay through the ones of the macros that are part of the higher level. Modified macro timing models corresponding with one or more of the macros are generated, and only the modified macro timing models associated with the macros that are part of the higher level modify corresponding loaded macro timing models to continue the higher-level timing analysis.

### BACKGROUND

The present invention relates to integrated circuit design, and more specifically, to the dynamic update of macro timing models during higher-level timing analysis.

An integrated circuit, such as a microprocessor, for example, is a collection of electronic circuits that are also referred to as a chip. Integrated circuit design involves several phases. In a logic design phase, transistors and other components (e.g., buffers, capacitors) that must be interconnected to fulfill the desired functionality of the integrated circuit are determined. In the physical synthesis phase, the placement of the components is determined. In addition to functionality, timing requirements are established for the final integrated circuit such that the chip must perform the specified functionality within a specified duration of time. In order to meet the timing requirements, timing analysis is performed at different phases of the design, and the design is modified to address components deemed responsible for the failure to meet timing requirements. An exemplary integrated circuit can include many components (e.g., over ten billion transistors). The integrated circuit design may be performed hierarchically. A timing analysis at a high hierarchical level, which involves more components, will be more time-consuming than a timing analysis at a lower hierarchical level. For example, a chip-level timing analysis can require hours (e.g., ten hours or more) to complete. As a result, when components are modified to address failures in timing requirements or other performance issues, it can be inefficient to perform another high level timing analysis. Consequently, high level (e.g., chip-level) timing analysis may only be performed periodically (e.g., once a week) while different portions of the chip design are modified more frequently.

### SUMMARY

Embodiments of the present invention are directed to systems and methods to perform integrated circuit design. The method includes partitioning a design of an integrated circuit into two or more hierarchical levels such that a lowest level of the two or more hierarchical levels includes two or more macros and a higher level of the two or more hierarchical levels includes some or all of the two or more macros. Each of the two or more macros includes two or more components and the two or more components includes a transistor. The method also includes obtaining a macro timing model corresponding with each of the two or more macros. The macro timing model corresponding with each of the two or more macros indicates a delay through the macro. The macro timing model corresponding with ones of the two or more macros that are part of the higher level are loaded to perform higher-level timing analysis. The higher-level timing analysis indicates a delay through the ones of the two or more macros that are part of the higher level. One or more modified macro timing models corresponding with one or more of the ones of the two or more macros that are part of the higher level are generated, and only one or more of the macro timing models are modified using the one or more modified macro timing models associated with the one or more of the ones of the two or more macros that are part of the higher level to continue the higher-level timing analysis.

### BRIEF DESCRIPTION OF THE DRAWINGS

The examples described throughout the present document will be better understood with reference to the following drawings and description. The components in the figures are not necessarily to scale. Moreover, in the figures, like-referenced numerals designate corresponding parts throughout the different views.

FIG. 1 is a block diagram of a system to perform a dynamic update of macro timing models during higher-level timing analysis according to one or more embodiments of the invention;

FIG. 2 illustrates an exemplary macro timing model that can be used in higher-level timing analysis according to one or more embodiments of the invention;

FIG. 3 is a process flow of methods of performing dynamic updates of macro timing models during higher-level timing analysis according to one or more embodiments of the invention; and

FIG. 4 is a process flow of a method of fabricating the integrated circuit based on performing higher-level timing analysis according to one or more embodiments of the invention.

### DETAILED DESCRIPTION

As previously noted, in prior chip design methodologies, time-consuming high level timing analysis may be performed infrequently. For example, chip-level timing analysis may only be performed periodically (e.g., once a week) while portions of the chip design are modified more frequently. As a result, the chip-level timing analysis may be performed with outdated designs. Embodiments of the systems and methods detailed herein relate to the dynamic update of macro timing models during higher-level timing analysis. According to one or more embodiments of the invention, the chip is partitioned into macros, each of which includes transistors and other components. A macro timing model, generated for each macro, models the delay through the components of the macro from the inputs to the outputs of the macro. A modified macro timing model may be substituted for the previous macro timing model in higher-level timing analysis at any time. The higher-level timing analysis does not require initiating a new timing analysis each time a modified macro timing model is available.

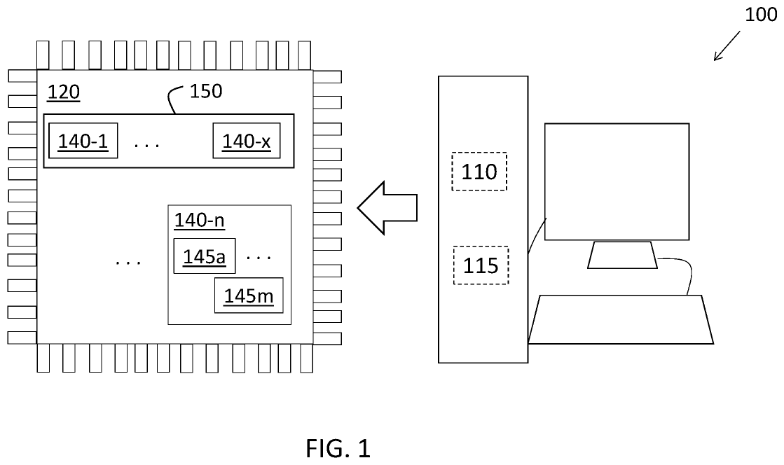

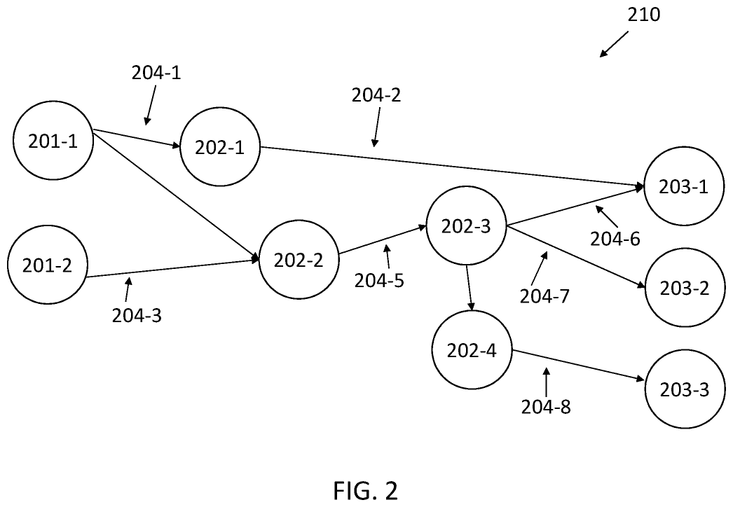

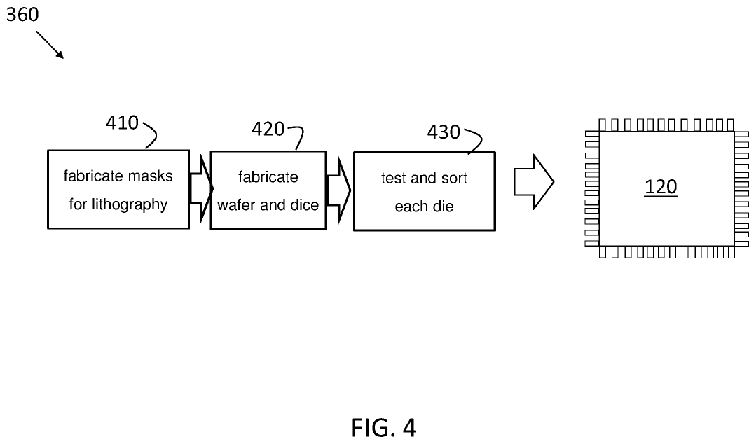

FIG. 1 is a block diagram of a system 100 to perform dynamic update of macro timing models during chip-level timing analysis according to one or more embodiments of the invention. The system 100 includes processing circuitry 110 and memory 115 that is used to generate the design that is ultimately fabricated into an integrated circuit 120. The steps involved in the fabrication of the integrated circuit 120 are well-known and only briefly described herein and with reference to FIG. 4. The physical layout is finalized, in part, based on chip-level timing analysis that includes dynamic update of macro timing models 210 (FIG. 2) according to embodiments of the invention. The finalized physical layout is provided to a foundry. Masks are generated for each layer of the integrated circuit 120 based on the finalized physical layout. Then, the wafer is processed in the sequence of the mask order. The processing includes photolithography and etch. The fabrication is further discussed with reference to FIG. 4.

An exemplary hierarchical organization of the integrated circuit 120 is shown in FIG. 1, but more or fewer hierarchical levels are contemplated in alternate embodiments. As shown, the integrated circuit design is partitioned into macros 140-1 through 140-n (generally referred to as 140). An exemplary macro 140-n is shown with components 145a through 145m (generally referred to as 145) that are interconnected by wires (not shown). Two or more macros 140 can be grouped into units 150. While only one exemplary unit 150 is indicated, all of the macros 140 may be part of a unit 150. This the three hierarchical levels shown in FIG. 1 include the macro level, the unit level, and the chip level.

One or more signals are input to each macro 140 and traverse paths defined by the wires through the components 145 to one or more outputs of the macro 140. The integrated circuit 120, which is made up of all the macros 140 that are part of all the units 150, has one or more signals that traverse the macros 140 to one or more outputs. Thus, the timing requirement for the integrated circuit 120, which defines the maximum duration within which the signals must traverse the collection of macros 140, can be broken down and addressed at the macro level as timing requirements for each of the macros 140. As further detailed, macros 140 that fail to meet their individual timing requirements may be redesigned to ensure that, when put together with other macros 140, the integrated circuit 120 meets its timing requirement.

FIG. 2 illustrates an exemplary macro timing model 210 that can be used in higher-level timing analysis according to one or more embodiments of the invention. According to the exemplary hierarchical scheme discussed with reference to FIG. 1, higher-level timing analysis refers to timing analysis of a unit 150 that includes two or more macros 140 or chip-level timing analysis of the integrated circuit 120 that includes all the units 150 that together include all the macros 140. In the exemplary macro timing model 210 shown in FIG. 2, input nodes 201-1, 201-2 (referred to generally as 201) receive input signals that are transmitted over edges 204-1 through 204-8 (referred to generally as 204) to other nodes 202-1, 202-2, 202-3, 202-4 (referred to generally as 202) and ultimate to output nodes 203-1, 203-2, 203-3 (referred to generally as 203). The input nodes 201 may receive the input signals from output nodes 203 of one or more other macros 140, and the output nodes 203 may provide input signals to input nodes 201 of one or more other macros 140. The input nodes 201, other nodes 202, and output nodes 203 represent components 145 of the macro 140, and the edges 204 represent wires that interconnect the components 145. Different macros 140 can have different numbers of components 145 such that different macro timing models 210 can have a different number of nodes 201, 202, 203 and edges 204.

Static timing analysis is well-known and only generally described herein. For each macro timing model 210, the arrival time of the signal at each node 201, 202, 203 and edge 204 and the propagation delay through each node 201, 202, 203 and edge 204 is used to determine the overall delay represented by the associated macro 140. The delay associated with a given component 145 such as a transistor can be determined using a known model (e.g., Simulation Program with Integrated Circuit Emphasis (SPICE) simulation) or established library. For example, when an input signal arrives at input node 201-2, the arrival time and delay associated with input node 201-2 are added to obtain the arrival time at the start of the edge 204-3 that connects input node 201-2 with node 202-2. This arrival time is added to the propagation delay through the edge 204-3 to obtain the arrival time at the node 202-2. In this way, the arrival time at the outputs of each of the output nodes 203 is obtained. The difference between the latest arrival time at the output of the output nodes 203 and the earliest arrival time at the input of the input nodes 201 gives the delay for the macro 140 associated with the macro timing model 210.

In reality, a set of arrival times, an early arrival time and a late arrival time, is associated with each node 201, 202, 203 and edge 204. This is because arrival time refers to the time at which the voltage of the signal reaches, for example, half of the maximum voltage value. On-chip and environmental variations result in the so-called early mode and late mode arrival times. When two edges, for example, one that reaches a data node 202 and the other that reaches a clock node 202, are fed by a common edge 204, the late mode arrival time of that common edge is considered with respect to the data node 202 while the early mode arrival time of the same common edge is considered with respect to the clock node 202. This can result in a more pessimistic timing result than is realistic because the common edge 204 cannot actually exhibit both the early mode arrival time and the late mode arrival time. Known techniques to address this situation are referred to as common path pessimism removal (CPPR). When a delay is less than expected, the path is said to have timing slack. For example, if the arrival time at the input to node 202-3 is earlier than the expected arrival time, then the path associated with edge 204-5 has timing slack. This slack may be used, according to a known technique referred to as slack stealing, to improve timing in another part of the macro 140 associated with the macro timing model 210. Embodiments of the invention include all of the known techniques for macro-level timing analysis and redesign of a macro 140 for improvement in timing.

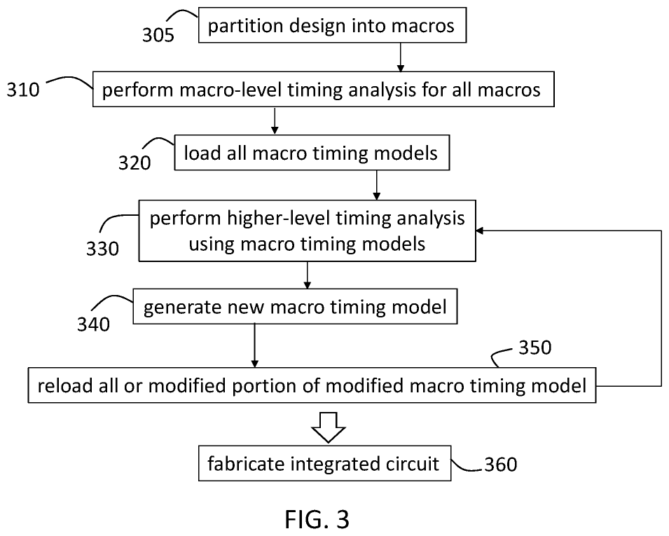

Prior approaches have also introduced efficiencies at the macro level. For example, incremental timing analysis of a macro timing model 210 can involve changing one or more nodes 202 or edges 204 and re-performing static timing analysis only for the paths that have changed. This is possible at the macro level because there are fewer components 145 involved than at the chip level. As previously noted, changes at the macro level 140 have previously required reloading the design to perform another higher-level timing analysis such as, for example, a chip-level timing analysis. Embodiments of the invention, which are further detailed with reference to FIG. 3, facilitate dynamic update of macro timing models 210 during higher-level timing analysis.

FIG. 3 is a process flow of methods of performing dynamic update of macro timing models 210 during higher-level timing analysis according to one or more embodiments of the invention. At block 305, partitioning the design into macros 140 refers to identifying each collection of components 145 as a macro 140. At block 310, performing macro-level timing analysis for all macros 140 includes generating a macro timing model 210 for each macro 140 and obtaining the delay associated with each macro 140 as discussed with reference to FIG. 2.

At block 320, the processes include loading all macro timing models 210 that make up the higher-level (e.g., the unit 150, the integrated circuit 120). As previously noted, this process of loading all macro timing models 210 was previously done every time higher-level timing analysis was initiated with modified macro timing models 210. However, according to one or more embodiments of the invention, this process of loading all the macro timing models 210 of the higher level (e.g., unit 150, integrated circuit 120) need not be repeated. At block 330, the processes include performing higher-level timing analysis using the macro timing models 210 for all the macros 140 that are part of the higher level (e.g., unit 150, integrated circuit 120).

At block 340, generating a new macro timing model 210 may occur in a number of ways. Depending on the phase of the design, the design of the macro 140 associated with the macro timing model 210 may be changed because the logic design is still being worked out. The design of the macro 140 may also be changed because of the results of the higher-level timing analysis (at block 330). For example, even if a macro 140 meets macro-level timing requirements, it may be modified to improve the overall performance at a higher hierarchical level. As the discussion of FIG. 2 indicates, a change in the components 145 or interconnections of the macro 140 will likely result in changes to the corresponding macro timing model 210. In addition, the macro timing model 210 may be changed without any change to the corresponding macro 140.

At block 350, the processes include reloading the modified macro timing models 210, according to an exemplary embodiment of the invention. According to an alternate embodiment, the process at block 350 includes reloading only the portions of the modified macro timing models 210 that have changed. The process at block 350 can be performed according to different embodiments. According to an exemplary embodiment, all new macro timing models 210 associated with the higher level can be automatically reloaded at one time (e.g., once a day). For example, all modified macro timing models 210 associated with a particular unit 140 or all modified macro timing models 210 of the entire integrated circuit 120 may be reloaded periodically. According to another exemplary embodiment, a designer can specify the reload of a given modified macro timing model 210.

Previously obtained information that is no longer applicable to the modified macro timing models 210 can be invalidated. This invalidation applies to changes in macro timing models 210 that may or may not have associated changes to the macros 140. With all or the modified portion of the modified macro timing models 210, associated with the modified macros 140, reloaded at block 350, the higher-level timing analysis at block 330 is resumed. Thus, according to embodiments of the invention, higher-level timing analysis that incorporates modified macro timing models 210 without the need to reload all macro timing models 210 is facilitated. This can be referred to as incremental higher-level timing analysis. As FIG. 3 indicates, when the integrated circuit design passes timing and other requirements and placement of the components 145 of all the macros 140 is performed, a final design is provided to a foundry for fabrication of the integrated circuit 120, the physical implementation of the design, at block 360.

FIG. 4 is a process flow of a method of fabricating the integrated circuit 120 designed according to one or more embodiments of the invention. Once the physical design data is obtained, based, in part, on performing dynamic update of macro timing models 210 during higher-level timing analysis according to one or more embodiments of the invention, the processes shown in FIG. 4 can be performed to fabricate the integrated circuit 120. Generally, a wafer with multiple copies of the final design is fabricated and cut (i.e., diced) such that each die is one copy of the integrated circuit 120. At block 410, the processes include fabricating masks for lithography based on the finalized physical layout. At block 420, fabricating the wafer includes using the masks to perform photolithography and etching. Once the wafer is diced, testing and sorting each die is performed, at block 430, to filter out any faulty die.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method of performing integrated circuit design, the method comprising:
partitioning, using a processor, a design of an integrated circuit into two or more hierarchical levels such that a lowest level of the two or more hierarchical levels includes two or more macros and a higher level of the two or more hierarchical levels includes some or all of the two or more macros, wherein each of the two or more macros includes two or more components and the two or more components includes a transistor;
obtaining, using the processor, a macro timing model corresponding with each of the two or more macros, wherein the macro timing model corresponding with each of the two or more macros indicates a delay through the macro;
loading, using the processor, the macro timing model corresponding with ones of the two or more macros that are part of the higher level to perform higher-level timing analysis, wherein the higher-level timing analysis indicates a delay through the ones of the two or more macros that are part of the higher level;
generating, using the processor, one or more modified macro timing models corresponding with one or more of the ones of the two or more macros that are part of the higher level; and
modifying, using the processor, only one or more of the macro timing models using the one or more modified macro timing models associated with the one or more of the ones of the two or more macros that are part of the higher level to continue the higher-level timing analysis.

2. The computer-implemented method according to claim 1, further comprising fabricating the integrated circuit based on finalizing the integrated circuit design.

3. The computer-implemented method according to claim 1, further comprising generating the macro timing model corresponding with each of the two or more macros based on performing macro-level timing analysis.

4. The computer-implemented method according to claim 3, wherein the performing the macro-level timing analysis includes determining the delay associated with signals input to the macro and output by the macro for each of the two or more macros.

5. The computer-implemented method according to claim 1, wherein the modifying the one or more of the macro timing models using the one or more modified macro timing models includes replacing previously loaded ones of the one or more of the macro timing models with corresponding ones of the one or more modified macro timing models.

6. The computer-implemented method according to claim 1, wherein the modifying the one or more of the macro timing models using the one or more modified macro timing models includes replacing only modified portions of the previously loaded ones of the one or more of the macro timing models in corresponding ones of the one or more modified macro timing models.

7. The computer-implemented method according to claim 1, wherein performing the higher-level timing analysis includes performing chip-level timing analysis for all of the two or more macros, and the chip-level timing analysis includes determining the delay through the integrated circuit for signals input to the integrated circuit and output by the integrated circuit based on the delay through each of the two or more macros that makes up the integrated circuit.

8. A system to perform integrated circuit design, the system comprising:
a memory device configured to store a design of an integrated circuit; and
a processor configured to partition the design into two or more hierarchical levels such that a lowest level of the two or more hierarchical levels includes two or more macros and a higher level of the two or more hierarchical levels includes some or all of the two or more macros, each of the two or more macros including two or more components and the two or more components including a transistor, to obtain a macro timing model corresponding with each of the two or more macros, the macro timing model corresponding with each of the two or more macros indicating a delay through the macro, to load the macro timing model corresponding with ones of the two or more macros that are part of the higher level to perform higher-level timing analysis, the higher-level timing analysis indicating a delay through the ones of the two or more macros that are part of the higher level, to generate one or more modified macro timing models corresponding with one or more of the ones of the two or more macros that are part of the higher level, and to modify only one or more of the macro timing models using the one or more modified macro timing models associated with the one or more of the ones of the two or more macros that are part of the higher level to continue the higher-level timing analysis.

9. The system according to claim 8, wherein a finalized integrated circuit design is used to fabricate the integrated circuit.

10. The system according to claim 8, wherein the processor is configured to generate the macro timing model corresponding with each of the two or more macros by performing macro-level timing analysis.

11. The system according to claim 10, wherein the processor performing the macro-level timing analysis includes determining the delay associated with signals input to the macro and output by the macro for each of the two or more macros.

12. The system according to claim 8, wherein the processor is configured to modify the one or more of the macro timing models using the one or more modified macro timing models by replacing previously loaded ones of the one or more of the macro timing models with corresponding ones of the one or more modified macro timing models.

13. The system according to claim 8, wherein the processor is configured to modify the one or more of the macro timing models using the one or more modified macro timing models by replacing only modified portions of the previously loaded ones of the one or more of the macro timing models in corresponding ones of the one or more modified macro timing models.

14. The system according to claim 8, wherein the higher-level timing analysis is chip-level timing analysis for all of the two or more macros, and the processor is configured to perform the chip-level timing analysis by determining the delay through the integrated circuit for signals input to the integrated circuit and output by the integrated circuit based on the delay through each of the two or more macros that makes up the integrated circuit.

15. A computer program product for performing integrated circuit design, the computer program product comprising a computer readable storage medium having program instructions embodied therewith, the program instructions executable by a processor to perform a method comprising:
partitioning a design of an integrated circuit into two or more hierarchical levels such that a lowest level of the two or more hierarchical levels includes two or more macros and a higher level of the two or more hierarchical levels includes some or all of the two or more macros, wherein each of the two or more macros includes two or more components and the two or more components includes a transistor;
obtaining a macro timing model corresponding with each of the two or more macros, wherein the macro timing model corresponding with each of the two or more macros indicates a delay through the macro;
loading the macro timing model corresponding with ones of the two or more macros that are part of the higher level to perform higher-level timing analysis, wherein the higher-level timing analysis indicates a delay through the ones of the two or more macros that are part of the higher level;
generating one or more modified macro timing models corresponding with one or more of the ones of the two or more macros that are part of the higher level; and
modifying only one or more of the macro timing models using the one or more modified macro timing models associated with the one or more of the ones of the two or more macros that are part of the higher level to continue the higher-level timing analysis.

16. The computer program product according to claim 15, wherein the method further comprises fabricating the integrated circuit based on finalizing the integrated circuit design.

17. The computer program product according to claim 15, wherein the method further comprises generating the macro timing model corresponding with each of the two or more macros based on performing macro-level timing analysis.

18. The computer program product according to claim 15, wherein the modifying the one or more of the macro timing models using the one or more modified macro timing models includes replacing previously loaded ones of the one or more of the macro timing models with corresponding ones of the one or more modified macro timing models.

19. The computer program product according to claim 15, wherein the modifying the one or more of the macro timing models using the one or more modified macro timing models includes replacing only modified portions of the previously loaded ones of the one or more of the macro timing models in corresponding ones of the one or more modified macro timing models.

20. The computer program product according to claim 15, wherein performing the higher-level timing analysis includes performing chip-level timing analysis for all of the two or more macros, and the chip-level timing analysis includes determining the delay through the integrated circuit for signals input to the integrated circuit and output by the integrated circuit based on the delay through each of the two or more macros that makes up the integrated circuit.
